(19) United States
(12) Patent Application Publication
(10) Pub. No.: US 2019/0226393 A1
(43) Pub. Date: Jul. 25, 2019

(54) TURBOCHARGER

(71) Applicant: KABUSHIKI KAISHA TOYOTA JIDOSHOKKI, Aichi-ken (JP)

(72) Inventors: Tatsuya ARAKAWA, Aichi-ken (JP); Tsuyoshi UESUGI, Aichi-ken (JP); Keita KUROSU, Aichi-ken (JP); Yosuke MEZAKI, Aichi-ken (JP)

(73) Assignee: KABUSHIKI KAISHA TOYOTA JIDOSHOKKI, Aichi-ken (JP)

(21) Appl. No.: 16/252,986

(22) Filed: Jan. 21, 2019

(30) Foreign Application Priority Data
Jan. 23, 2018 (JP) 2018-008862

(51) Int. Cl. F02B 39/08; F01D 15/08; F04D 25/04; F04D 29/00; F04D 29/054; F04D 29/059; F04D 29/58; F01D 25/18; F02B 39/14; F01D 25/30

(52) U.S. Cl. CPC F02B 39/08; F05D 2260/98; F04D 25/045; F04D 29/002; F04D 29/054; F04D 29/059; F04D 29/5846; F01D 25/183; F02B 39/14; F01D 25/305; F05D 2220/40; F05D 2240/50; F05D 2240/70; F05D 2260/201; F01D 15/08

(57) ABSTRACT

A turbocharger includes a bearing housing, a compressor housing connected to the bearing housing via a seal plate, a compressor impeller, a diffuser passage, a diffuser surface, and a cooling passage. The bearing housing has a first facing surface, and a first extending surface that is formed continuously with the first facing surface. The seal plate has a second facing surface that faces the first facing surface, and a second extending surface that is formed continuously with the second facing surface. The second extending surface faces the first extending surface in a radial direction of the impeller shaft. The cooling passage is defined by the first facing surface, the first extending surface, the second facing surface, and the second extending surface.

### CROSS-REFERENCE TO RELATED APPLICATION

This application claims priority to Japanese Patent Application No. 2018-008862 filed on Jan. 23, 2018, the entire disclosure of which is incorporated herein by reference.

### BACKGROUND ART

The present disclosure relates to a turbocharger.

A turbocharger includes a bearing housing rotatably supporting the impeller shaft and a compressor housing that is connected to one end of the bearing housing via a seal plate and through which intake air supplied to the internal combustion engine flows. A diffuser passage is formed extending annularly around the compressor impeller between the compressor housing and the seal plate. The turbocharger further includes a turbine impeller that is rotated by the exhaust gas discharged from the internal combustion engine, and a compressor impeller that rotates integrally with the turbine impeller via the impeller shaft.

When the turbine impeller is rotated by the exhaust gas discharged from the internal combustion engine and the compressor impeller rotates integrally with the turbine impeller via the impeller shaft, the intake air flowing through the compressor housing is compressed by the rotation of the compressor impeller. The compressed intake air is decelerated while passing through the diffuser passage, and the velocity energy of the intake air is converted into pressure energy. Then, the high-pressured intake air is discharged to the scroll passage and is supplied to the internal combustion engine. The intake efficiency of the internal combustion engine is enhanced and the performance of the internal combustion engine is improved by such supercharging of the intake air to the internal combustion engine by the turbocharger.

In the seal plate, the temperature of the diffuser surface that is the wall surface facing the diffuser passage is increased by the intake air compressed by the rotation of the compressor impeller passing through the diffuser passage. Thus, for example, when the intake air contains oil, the oil is carbonized at the diffuser surface and accumulated in the diffuser passage, with the result that the cross-sectional area of the diffuser passage becomes small, which makes supercharging of the intake air to the internal combustion engine by the turbocharger difficult.

Japanese Patent Application Publication No. 62-178729 discloses a turbocharger in which a ring groove formed in the end surface of the bearing housing facing the seal plate and a cooling passage is defined by the ring groove and the end surface of the seal plate facing the bearing housing, so that the diffuser surface is cooled by fluid flowing through the cooling passage in this turbocharger. This configuration may prevent the diffuser surface to become excessively high temperature, which suppresses the carbonization of oil at the diffuser surface.

In the turbocharger of the above-cited Publication, however, the wall thickness of the bearing housing in the rotation axis direction of the impeller shaft needs to be secured so as to form an annular groove in the end surface of the bearing housing, which increases the size of the bearing housing in the rotation axis direction of the impeller shaft, so that the size of the turbocharger in the rotation axis direction of the impeller shaft is increased.

The present disclosure is directed to providing a turbocharger that permits reducing the size of the turbocharger in the rotation axis direction of the impeller shaft.

### SUMMARY

In accordance with the present disclosure, there is provided a turbocharger including a bearing housing rotatably supporting an impeller shaft, a compressor housing that is connected to one end of the bearing housing in a rotation axis direction of the impeller shaft via a seal plate and through which intake air supplied to an internal combustion engine flows, a compressor impeller accommodated in the compressor housing and configured to compress the intake air, a diffuser passage that is formed between the compressor housing and the seal plate, that extends in an annular shape around the compressor impeller, and through which the intake air compressed by the compressor impeller flows, a diffuser surface that is part of the seal plate and that is a wall surface facing the diffuser passage, and a cooling passage through which a fluid that cools the diffuser surface flows. The bearing housing has a first facing surface that faces the seal plate in the rotation axis direction of the impeller shaft, and a first extending surface that is formed continuously with the first facing surface and extends in a direction that intersects with the first facing surface from the first facing surface toward the seal plate. The seal plate has a second facing surface that faces the first facing surface in the rotation axis direction of the impeller shaft, and a second extending surface that is formed continuously with the second facing surface and extend in a direction that intersects with the second facing surface from the second facing surface toward the bearing housing, wherein the second extending surface faces the first extending surface in a radial direction of the impeller shaft. The cooling passage is defined by the first facing surface, the first extending surface, the second facing surface, and the second extending surface.

### BRIEF DESCRIPTION OF THE DRAWINGS

FIG. 1 is a side sectional view of a turbocharger according to an embodiment of the present disclosure;

FIG. 2 is a partially enlarged sectional view of the turbocharger of FIG. 1;

FIG. 3 is a partially enlarged sectional view of the turbocharger, showing around a cooling passage; and

FIG. 4 is a perspective view of a seal plate.

### DETAILED DESCRIPTION OF THE EMBODIMENTS

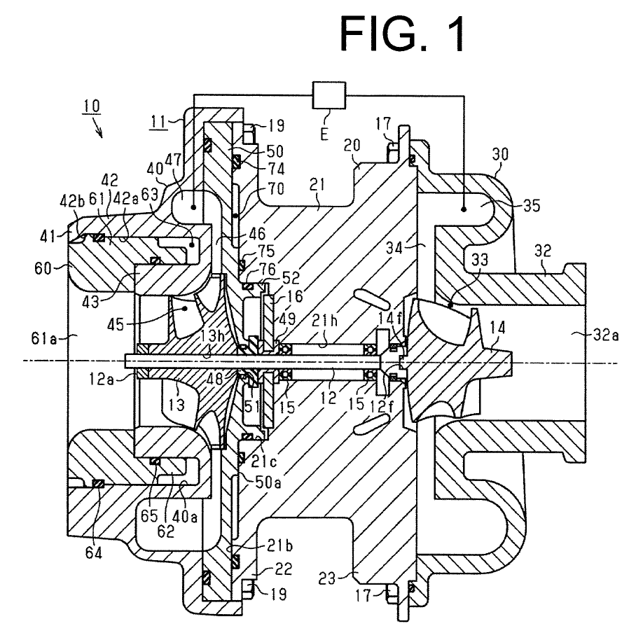

The following will describe an embodiment of a turbocharger according to the present disclosure with reference to FIGS. 1 to 4. FIG. 1 depicts a turbocharger 10 having a housing 11 that includes a bearing housing 20, a turbine housing 30, and a compressor housing 40. Intake air to be supplied to an internal combustion engine E flows through the compressor housing 40. Exhaust gas discharged from the internal combustion engine E flows through the turbine housing 30.

The bearing housing 20 rotatably supports an impeller shaft 12. A compressor impeller 13 is connected to one end of the impeller shaft 12 in the rotation axis direction thereof. A turbine impeller 14 is connected to the other end of the impeller shaft 12 in the rotation axis direction thereof.

A seal plate 50 is interposed between the compressor housing 40 and one end of the bearing housing 20 in the rotation axis direction of the impeller shaft 12. The compressor housing 40 is connected to the one end of the bearing housing 20 in the rotation axis direction of the impeller shaft 12 via the seal plate 50. The turbine housing 30 is connected to the other end of the bearing housing 20 in the rotation axis direction of the impeller shaft 12.

The bearing housing 20 includes a tubular main body 21. The main body 21 of the bearing housing 20 has an insertion hole 21h through which the impeller shaft 12 is inserted. The main body 21 rotatably supports the impeller shaft 12 inserted through the insertion hole 21h through a radial bearing 15. The axis direction of the main body 21 coincides with the rotation axis direction of the impeller shaft 12.

A recess 21c having a circular hole shape is formed in one end surface 21b of the bearing housing 20 in the rotation axis direction of the impeller shaft 12. The insertion hole 21h is opened at the bottom surface of the recess 21c. The diameter of the recess 21c is greater than that of the insertion hole 21h. The axis of the recess 21c coincides with the axis of the insertion hole 21h. A thrust bearing 16 is accommodated in the recess 21c. The thrust bearing 16 is accommodated in the recess 21c in contact with the bottom surface of the recess 21c.

The bearing housing 20 includes a first flange portion 22 and a second flange portion 23 that protrude outwardly from the outer peripheral surface of the main body 21 in the radial direction of the impeller shaft 12. The first flange portion 22 and the second flange portion 23 disposed at one end and the other end of the main body 21 in the axis direction of the main body 21. The first flange portion 22 and the second flange portion 23 have an annular shape.

The turbine housing 30 is attached to the second flange portion 23 by screws 17. The turbine housing 30 has a turbine tubular portion 32. A discharge port 32a is formed in the turbine tubular portion 32. The discharge port 32a extends in the rotation axis direction of the impeller shaft 12. The axis of the discharge port 32a coincides with the rotation axis of the impeller shaft 12.

A turbine chamber 33, a communication passage 34, and a turbine scroll passage 35 are formed in the turbine housing 30. The turbine impeller 14 is accommodated in the turbine chamber 33. The turbine scroll passage 35 has a scroll shape and is formed around the outer periphery of the turbine chamber 33. Thus, the turbine scroll passage 35 surrounds the turbine chamber 33. Exhaust gas discharged from the internal combustion engine E flows into the turbine scroll passage 35. The communication passage 34 has an annular shape extending around the turbine chamber 33 and provides communication between the turbine scroll passage 35 and the turbine chamber 33. The turbine chamber 33 is in communication with the discharge port 32a. Exhaust gas having passed through the turbine chamber 33 is guided to the discharge port 32a.

The turbine impeller 14 has a fitting projection 14f projecting toward the insertion hole 21h. A fitting recess 12f is formed in the other end surface of the impeller shaft 12 in the rotation axis direction to which the fitting projection 14f is fitted. The turbine impeller 14 is attached to the impeller shaft 12 by welding or the like so that the turbine impeller 14 is integrally rotatable with the impeller shaft 12 in a state where the fitting projection 14f is fitted to the fitting recess 12f of the impeller shaft 12. The turbine impeller 14 is rotated by the exhaust gas drawn into the turbine chamber 33, and the impeller shaft 12 rotates integrally with the rotation of the turbine impeller 14.

The seal plate 50 has an insertion hole 51 through which the impeller shaft 12 is inserted. A cylindrical insertion tube portion 52 is formed protruding around the insertion hole 51 of the seal plate 50 on an end surface 50a of the seal plate 50 that is opposite the compressor housing 40. The insertion tube portion 52 is inserted into the recess 21c. The thrust bearing 16 is located between the insertion tube portion 52 and the bottom surface of the recess 21c in the rotation axis direction of the impeller shaft 12 and located inward of the insertion tube portion 52 in the radial direction of the impeller shaft 12.

The compressor housing 40 has a cylindrical shape having an opening at an end that is adjacently to the bearing housing 20. Screws 19 are inserted through the first flange portion 22 and the seal plate 50 and screwed into the compressor housing 40, so that the compressor housing 40 is connected to the one end of the bearing housing 20 in the rotation axis direction of the impeller shaft 12 with the seal plate 50 interposed between the end of the compressor housing 40 having the opening and the bearing housing 20. The opening of the compressor housing 40 is closed by the seal plate 50.

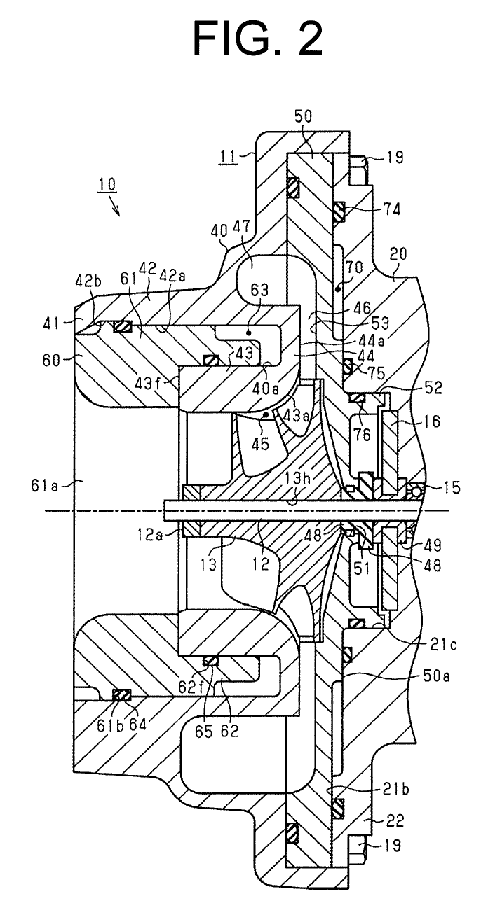

As shown in FIG. 2, the compressor housing 40 has a cylindrical compressor tubular portion 42 projecting on a side of the compressor housing 40 that is opposite from the opening of the compressor housing 40. The compressor housing 40 further has a cylindrical shroud portion 43 located inside the compressor tubular portion 42. The axis of the compressor tubular portion 42 and the axis of the shroud portion 43 coincide with each other, and the axes of the compressor tubular portion 42 and the shroud portion 43 coincide with the rotation axis of the impeller shaft 12. The compressor housing 40 is formed by aluminum die-cast molding.

The compressor tubular portion 42 has a small diameter portion 42a and a large diameter portion 42b, and the diameter of the large diameter portion 42b is greater than that of the small diameter portion 42a. The small diameter portion 42a is located closer to the seal plate 50 than the large diameter portion 42b is.

The compressor tubular portion 42 and the shroud portion 43 are connected by an annular diffuser wall 44. The diffuser wall 44 connects the peripheral portion of the inner peripheral surface of the small diameter portion 42a of the compressor tubular portion 42 on the seal plate 50 side with the peripheral portion of the outer peripheral surface of the shroud portion 43 on the seal plate 50 side. The diffuser wall 44 extends in the radial direction of the impeller shaft 12. The dimension of the shroud portion 43 projecting out from the diffuser wall 44 is smaller than the dimension of the compressor tubular portion 42 projecting out from the diffuser wall 44. The small diameter portion 42a extends to a position that is further than an end surface 43f of the shroud portion 43 protruding from the diffuser wall 44 in a direction opposite from the diffuser wall 44.

The turbocharger 10 has a compressor impeller chamber 45, a diffuser passage 46, and a compressor scroll passage 47. The compressor impeller chamber 45 accommodates therein the compressor impeller 13. The compressor scroll passage 47 is formed extending around the outer periphery of the compressor impeller chamber 45 in a scroll shape. The diffuser passage 46 extends in an annular shape around the compressor impeller 13 and provides communication between the compressor impeller chamber 45 and the compressor scroll passage 47.

The compressor impeller chamber 45 is a space surrounded by the inner peripheral surface of the shroud portion 43 and the perimeter of the insertion hole 51 on the surface of the seal plate 50 on the compressor housing 40 side. The compressor impeller 13 is disposed inside the shroud portion 43. The compressor impeller 13 is accommodated in the compressor housing 40 and configured to compress the intake air drawn into the compressor impeller chamber 45. The inner peripheral surface of the shroud portion 43 has a shroud surface 43a facing the compressor impeller 13.

Part of the surface of the seal plate 50 on the compressor housing 40 side faces the diffuser wall 44 in the rotation axis direction of the impeller shaft 12. The diffuser passage 46 is formed between the diffuser wall 44 and such part of the seal plate 50 in the rotation axis direction of the impeller shaft 12. Thus, the diffuser passage 46 is formed between the compressor housing 40 and the seal plate 50. The seal plate 50 has a diffuser surface 53 that is a wall surface of the seal plate 50 facing the diffuser wall 44, which is a part of the seal plate 50 and faces the diffuser passage 46. The diffuser surface 53 has an annular shape extending along the diffuser wall 44. The diffuser wall 44 has a facing surface 44a facing the diffuser surface 53, which is part of the compressor housing 40 and the wall surface facing the diffuser passage 46. The edge portion of the facing surface 44a on the compressor impeller chamber 45 side is formed continuously with the shroud surface 43a. Intake air compressed by the compressor impeller 13 passes through the diffuser passage 46.

The compressor scroll passage 47 is formed by the inner bottom surface of the compressor housing 40 and the surface of the seal plate 50 on the compressor housing 40 side. The intake air having passed through the diffuser passage 46 is discharged to the compressor scroll passage 47. The intake air discharged to the compressor scroll passage 47 is supplied to the internal combustion engine E.

As shown in FIG. 1, the compressor impeller 13 has a shaft insertion hole 13h that extends in the rotation axis direction of the impeller shaft 12 and through which the impeller shaft 12 is inserted. The one end of the impeller shaft 12 in the rotation axis direction projects out in the compressor impeller chamber 45. The compressor impeller 13 is attached to the impeller shaft 12 by a nut 12a or the like so as to be rotatable integrally with the impeller shaft 12 with a portion of the impeller shaft 12 projecting out in the compressor impeller chamber 45 inserted through the shaft insertion hole 13h. An end of the compressor impeller 13 on the bearing housing 20 side is supported by the thrust bearing 16 via a seal ring collar 48 and a thrust collar 49. The thrust bearing 16 receives a load in the thrust direction acting on the compressor impeller 13.

As shown in FIG. 2, the inner peripheral surface of the small diameter portion 42a of the compressor tubular portion 42 and the outer peripheral surface of the shroud portion 43 are spaced away by a dimension of the diffuser wall 44 extending in the radial direction of the impeller shaft 12. An annular insertion recess 40a is formed by the inner peripheral surface of the small diameter portion 42a of the compressor tubular portion 42, the outer peripheral surface of the shroud portion 43, and the surface of the diffuser wall 44 opposite the facing surface 44a. Accordingly, the compressor housing 40 has the insertion recess 40a.

A passage forming member 60 is attached to the compressor housing 40. The passage forming member 60 has a cylindrical shape. The passage forming member 60 is formed by aluminum die-cast molding. The passage forming member 60 is inserted inside the compressor tubular portion 42. The passage forming member 60 has a main body 61 and an insertion portion 62. The main body 61 has a cylindrical shape and forms an intake air port 61a in its inside. The intake air port 61a extends in the rotation axis direction of the impeller shaft 12. The axis of the intake air port 61a coincides with the rotation axis of the impeller shaft 12.

The insertion portion 62 has a cylindrical shape and is inserted into the insertion recess 40a. Thus, the insertion portion 62, which is part of the passage forming member 60, is inserted into the insertion recess 40a. A passage 63 is formed by the insertion portion 62 and the insertion recess 40a. The passage 63 extends in an annular shape. A fluid that cools the facing surface 44a of the diffuser wall 44 flows through the passage 63.

An annular mounting recess 61b is formed in the outer peripheral surface of the main body 61. An annular sealing member 64 made of rubber is mounted to the mounting recess 61b. The sealing member 64 is in close contact with the mounting recess 61b and the inner peripheral surface of the large diameter portion 42b of the compressor tubular portion 42 and provides sealing between the outer peripheral surface of the main body 61 and the inner peripheral surface of the large diameter portion 42b of the compressor tubular portion 42. This configuration permits suppressing the leakage of fluid from the passage 63 through the gap between the outer peripheral surface of the main body 61 and the inner peripheral surface of the large diameter portion 42b of the compressor tubular portion 42.

An annular mounting recess 62f is formed in the inner peripheral surface of the insertion portion 62. An annular sealing member 65 made of rubber is mounted to the mounting recess 62f. The sealing member 65 is in close contact with the mounting recess 62f and the outer peripheral surface of the shroud portion 43, and provides sealing between the inner peripheral surface of the insertion portion 62 and the outer peripheral surface of the shroud portion 43. This configuration permits suppressing the leakage of fluid from the passage 63 through the gap between the inner peripheral surface of the insertion portion 62 and the outer peripheral surface of the shroud portion 43.

The passage forming member 60 is attached to the compressor housing 40 by fastening the fastening portion 41, which formed by deforming part of the distal end of the compressor tubular portion 42 toward the passage forming member 60, on the outer peripheral surface of the passage forming member 60 in a state in which the passage forming member 60 is inserted inside the compressor tubular portion 42.

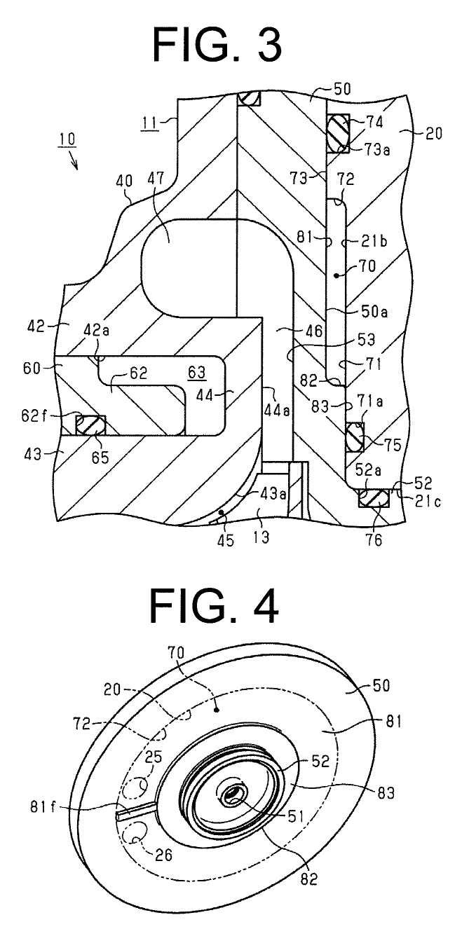

As shown in FIG. 3, the turbocharger 10 has a cooling passage 70. The cooling passage 70 is formed between the bearing housing 20 and the seal plate 50. A fluid that cools the diffuser surface 53 flows in the cooling passage 70.

The one end surface 21b of the bearing housing 20 has a first facing surface 71, a first extending surface 72, and an outer circumferential end surface 73. The first facing surface 71 is formed continuously with one end edge of the inner peripheral surface of the recess 21c in the rotation axis direction of the impeller shaft 12 and has an annular shape extending outwardly in the radial direction of the impeller shaft 12 from the one end edge of the recess 21c. The first facing surface 71 faces the end surface 50a of the seal plate 50 in the rotation axis direction of the impeller shaft 12. Part of the first facing surface 71 overlaps the diffuser surface 53 in the rotation axis direction of the impeller shaft 12.

The first extending surface 72 is formed continuously with the outer peripheral edge of the first facing surface 71. The first extending surface 72 has an annular shape and extends in a direction that intersects with the first facing surface 71 from the first facing surface 71 toward the seal plate 50. The first extending surface 72 extends in a direction that is perpendicularly to the first facing surface 71. Thus, the first extending surface 72 extends in the rotation axis direction of the impeller shaft 12. The first extending surface 72 overlaps a portion of the compressor housing 40 that is radially outward of the compressor scroll passage 47 in the rotation axis direction of the impeller shaft 12. Thus, the first facing surface 71 overlaps the compressor scroll passage 47 in the rotation axis direction of the impeller shaft 12.

The outer circumferential end surface 73 is formed continuously with the end of the first extending surface 72 opposite the first facing surface 71 and has an annular shape, extending outwardly in the radial direction of the impeller shaft 12 from the first extending surface 72. The outer circumferential end surface 73 faces the end surface 50a of the seal plate 50 in the rotation axis direction of the impeller shaft 12.

The end surface 50a of the seal plate 50 includes a second facing surface 81, a second extending surface 82, and an inner circumferential end surface 83. The second facing surface 81 has an annular shape, extending inwardly from the outer peripheral surface of the seal plate 50 in the radial direction of the impeller shaft 12. The second facing surface 81 is in surface contact with the outer circumferential end surface 73 of the bearing housing 20. In addition, the second facing surface 81 faces the first facing surface 71 in the rotation axis direction of the impeller shaft 12.

The second extending surface 82 is formed continuously with the inner peripheral edge of the second facing surface 81 and has an annular shape, extending in a direction that intersects with the second facing surface 81 from the second facing surface 81 toward the bearing housing 20. The second extending surface 82 extends in a direction that is perpendicularly to the second facing surface 81. Thus, the second extending surface 82 extends in the rotation axis direction of the impeller shaft 12.

The second extending surface 82 faces the first extending surface 72 in the radial direction of the impeller shaft 12. The second extending surface 82 is located inward of the first extending surface 72 in the radial direction of the impeller shaft 12. The second extending surface 82 overlaps the diffuser surface 53 in the rotation axis direction of the impeller shaft 12. Therefore, a radially inward portion of the second facing surface 81 overlaps the diffuser surface 53 in the rotation axis direction of the impeller shaft 12.

The inner circumferential end surface 83 is formed continuously with the end of the second extending surface 82 opposite the second facing surface 81, and has an annular shape, extending inwardly from the second extending surface 82 in the radial direction of the impeller shaft 12. The inner circumferential end surface 83 is in surface contact with a radially inward portion of the first facing surface 71 in the radial direction of the impeller shaft 12. The inner circumferential end surface 83 is formed continuously with the outer peripheral surface of the insertion tube portion 52.

The cooling passage 70 is defined by the first facing surface 71, the first extending surface 72, the second facing surface 81, and the second extending surface 82. The first extending surface 72 forms the outer peripheral surface of the cooling passage 70. The second extending surface 82 forms the inner peripheral surface of the cooling passage 70. The first extending surface 72 overlaps the portion of the compressor housing 40 that is located outward of the compressor scroll passage 47 in the radial direction of the impeller shaft 12, and the second extending surface 82 overlaps the diffuser surface 53 in the rotation axis direction of the impeller shaft 12. Accordingly, the cooling passage 70 overlaps the diffuser surface 53 and the compressor scroll passage 47 in the rotation axis direction of the impeller shaft 12.

As shown in FIG. 4, the cooling passage 70 is in communication with a supply port 25 and a discharge port 26 formed in the bearing housing 20. Fluid is supplied through the supply port 25 to the cooling passage 70. Fluid flows through the cooling passage 70 and is discharged therefrom through the discharge port 26. The supply port 25 and the discharge port 26 are disposed adjacently to each other in the circumferential direction of the cooling passage 70.

The supply port 25 and the discharge port 26 are partitioned by a partition wall 81f formed on the second facing surface 81. The partition wall 81f has a plate shape and protrudes from the second facing surface 81. Due to the presence of the partition wall 81f, the cooling passage 70 extends from the supply port 25 to the opposite side of the partition wall 81f in the circumferential direction of the cooling passage 70 (the clockwise direction in FIG. 4) and communicates with the discharge port 26. Fluid supplied from the supply port 25 to the cooling passage 70 flows in the direction opposite to the partition wall 81f in the circumferential direction of the cooling passage 70 to the discharge port 26 and is discharged from the discharge port 26.

As shown in FIG. 3, an annular mounting recess 73a is formed in the outer circumferential end surface 73 of the bearing housing 20. An annular sealing member 74 made of rubber is mounted to the mounting recess 73a. The sealing member 74 is in close contact with the mounting recess 73a and the second facing surface 81 and provides sealing between the second facing surface 81 and the outer circumferential end surface 73. This configuration permits suppressing the leakage of fluid from the cooling passage 70 through the gap between the second facing surface 81 and the outer circumferential end surface 73.

An annular mounting recess 71a is formed in a portion of the first facing surface 71 that is radially inward of the second extending surface 82 in the radial direction of the impeller shaft 12. An annular sealing member 75 made of rubber is mounted to the mounting recess 71a. The sealing member 75 is in close contact with the mounting recess 71a and the inner circumferential end surface 83 of the seal plate 50 and provides a sealing between the first facing surface 71 and the inner circumferential end surface 83. This configuration permits suppressing the leakage of fluid from the cooling passage 70 through the gap between the first facing surface 71 and the inner circumferential end surface 83.

An annular mounting recess 52a is formed in the outer peripheral surface of the insertion tube portion 52. An annular sealing member 76 made of rubber is mounted on the mounting recess 52a. The sealing member 76 is in close contact with the mounting recess 52a and the inner peripheral surface of the recess 21c and provides sealing between the outer peripheral surface of the insertion tube portion 52 and the inner peripheral surface of the recess 21c.

Lubricating oil is supplied in the bearing housing 20 to maintain the lubrication of the sliding parts such as the impeller shaft 12, the radial bearing 15, and the thrust bearing 16. Thus, lubricating oil is present in the bearing housing 20. For example, lubricating oil is present in the recess 21c. Although the lubricating oil in the recess 21c tends to flow into the cooling passage 70 through the gap between the outer peripheral surface of the insertion tube portion 52 and the inner peripheral surface of the recess 21c and the gap between the first facing surface 71 and the inner circumferential end surface 83, the sealing members 75, 76 prevent the lubricating oil from leaking to the cooling passage 70 from the recess 21c through the gap between the outer peripheral surface of the insertion tube portion 52 and the inner peripheral surface of the recess 21c and the gap between the first facing surface 71 and the inner circumferential end surface 83. In the present embodiment, the two sealing members 75 and 76 are provided between the bearing housing 20 and the seal plate 50 to prevent the lubricating oil in the bearing housing 20 from flowing into the cooling passage 70 through the gap between the bearing housing 20 and the seal plate 50.

The following will describe the operation of the present embodiment will be described.

The exhaust gas discharged from the internal combustion engine E is supplied to the turbine scroll passage 35, and is guided to the turbine chamber 33 through the communication passage 34. The exhaust gas is introduced into the turbine chamber 33, which rotates the turbine impeller 14. With the rotation of the turbine impeller 14, the compressor impeller 13 rotates integrally with the turbine impeller 14 through the impeller shaft 12. With the rotation of the compressor impeller 13, the intake air introduced into the compressor impeller chamber 45 through the intake air port 61a is compressed, which is decelerated while passing through the diffuser passage 46, and velocity energy of the intake air is converted to pressure energy. Then, the high-pressured intake air is discharged to the compressor scroll passage 47 and is supplied to the internal combustion engine E. Such supercharging of the intake air to the internal combustion engine E by the turbocharger 10 enhances the intake efficiency of the internal combustion engine E and thereby to improve the performance of the internal combustion engine E.

In the seal plate 50, the temperature of the diffuser surface 53 facing the diffuser passage 46 is increased by the intake air compressed by the rotation of the compressor impeller 13 passing through the diffuser passage 46. At this time, the diffuser surface 53 is cooled by fluid flowing through the cooling passage 70, so that the excessive rise in the temperature of the diffuser surface 53 is suppressed.

In the compressor housing 40, the temperature of the facing surface 44a of the diffuser wall 44 facing the diffuser passage 46 is increased by the intake air compressed by the rotation of the compressor impeller 13 passing through the diffuser passage 46. At this time, the facing surface 44a of the diffuser wall 44 is cooled by fluid flowing through the passage 63, so that the excessive rise in the temperature of the facing surface 44a of the diffuser wall 44 is suppressed.

The above-described embodiment offers the following effects.
(1) The cooling passage 70 is defined by the first facing surface 71, the first extending surface 72, the second facing surface 81, and the second extending surface 82. As compared with the case in which the cooling passage 70 is formed only by forming the annular groove on the end surface of the bearing housing 20 such as in the prior art, the thickness of the bearing housing 20 need not be increased so as to secure the space to form the annular groove. Therefore, the size of the bearing housing 20 in the rotation axis direction of the impeller shaft 12 may be reduced, with the result that the size of the turbocharger 10 in the rotation axis direction of the impeller shaft 12 may be reduced.
(2) The turbocharger of the present embodiment includes the two sealing members 75 and 76 that are provided between the bearing housing 20 and the seal plate 50, which prevents the lubricating oil in the bearing housing 20 from flowing into the cooling passage 70 through the gap between the bearing housing 20 and the seal plate 50. This configuration may be more effective to prevent lubricating oil in the bearing housing 20 from flowing into the cooling passage 70 through the gap between the bearing housing 20 and the seal plate 50, as compared with the case where only one sealing member is provided between the bearing housing 20 and the seal plate 50.
(3) The partition wall 81f that separates the supply port 25 and the discharge port 26 is provided on the second facing surface 81. Due to the partition wall 81f, the cooling passage 70 extends from the supply port 25 to the opposite side of the partition wall 81f in the circumferential direction of the cooling passage 70 and communicates with the discharge port 26. Accordingly, the fluid supplied from the supply port 25 to the cooling passage 70 flows towards the opposite side of the partition wall 81f in the circumferential direction of the cooling passage 70, which is then discharged from the discharge port 26. This configuration allows fluid to flow effectively in the circumferential direction of the cooling passage 70, so that the diffuser surface 53 may be cooled effectively.
(4) The excessive rise in the temperature of the diffuser surface 53 is suppressed by cooling the diffuser surface 53 by fluid flowing through the cooling passage 70. Thus, the carbonization of oil on the diffuser surface 53 may be suppressed even when oil is mixed in the intake air. If the carbonized oil is accumulated in the diffuser passage 46 thereby to reduce the cross-sectional area of the diffuser passage 46, the supercharging of intake air to the internal combustion engine E may become difficult. According to the configuration of the present embodiment, such trouble may be avoided.
(5) The excessive rise in the temperature of the facing surface 44a of the diffuser wall 44 may be suppressed by cooling the facing surface 44a of the diffuser wall 44 by fluid flowing through the passage 63. Thus, the carbonization of oil on the facing surface 44a of the diffuser wall 44 may be suppressed even when oil is mixed in the intake air. If the carbonized oil is accumulated in the diffuser passage 46 thereby to reduce the cross-sectional area of the diffuser passage 46, the supercharging of intake air to the internal combustion engine E may become difficult. According to the configuration of the present embodiment, such trouble may be avoided.

The above-described embodiment may be modified as follows.

Although the second extending surface 82 is located inward of the first extending surface 72 in the radial direction of the impeller shaft 12 in the above-described embodiment, the second extending surface 82 may be located outward of the first extending surface 72 in the radial direction of the impeller shaft 12.

The first extending surface 72 may extend in a direction oblique to the first facing surface 71. In short, the first extending surface 72 may be formed continuously with the first facing surface 71 and extend in a direction that intersects with the first facing surface 71 from the first facing surface 71 toward the seal plate 50.

The second extending surface 82 may extend in a direction oblique to the second facing surface 81. The second extending surface 82 may be formed continuously with the second facing surface 81, extend in a direction that intersects with the second facing surface 81 from the second facing surface 81 toward the bearing housing 20, and face the first extending surface 72 in the radial direction of the impeller shaft 12.

Three or more sealing members may be provided between the bearing housing 20 and the seal plate 50 so as to prevent lubricating oil in the bearing housing 20 from flowing into the cooling passage 70 through the gap between the bearing housing 20 and the seal plate 50. In other words, a plurality of sealing members may be provided between the bearing housing 20 and the seal plate 50 so as to prevent lubricating oil in the bearing housing 20 from flowing into the cooling passage 70 through the gap between the bearing housing 20 and the seal plate 50.

The sealing member 75 need not necessarily be provided between the outer peripheral surface of the insertion tube portion 52 and the inner peripheral surface of the recess 21c. For example, a plurality of sealing members may be provided side by side in the radial direction of the impeller shaft 12 between the first facing surface 71 and the inner circumferential end surface 83 of the seal plate 50.

One of the sealing members 75, 76 may be formed by a liquid gasket.

The turbocharger 10 may be formed with only one sealing member that is disposed between the bearing housing 20 and the seal plate 50 so as to prevent the lubricating oil in the bearing housing 20 from flowing into the cooling passage 70 through the gap between the bearing housing 20 and the seal plate 50.

What is claimed is:

1. A turbocharger comprising:
a bearing housing rotatably supporting an impeller shaft;
a compressor housing that is connected to one end of the bearing housing in a rotation axis direction of the impeller shaft via a seal plate and through which intake air supplied to an internal combustion engine flows;
a compressor impeller accommodated in the compressor housing and compressing the intake air;
a diffuser passage that is formed between the compressor housing and the seal plate, that has an annular shape extending around the compressor impeller, and through which the intake air compressed by the compressor impeller flows;
a diffuser surface that is part of the seal plate and that is a wall surface facing the diffuser passage; and
a cooling passage through which a fluid that cools the diffuser surface flows,
wherein the bearing housing has a first facing surface that faces the seal plate in the rotation axis direction of the impeller shaft, and a first extending surface that is formed continuously with the first facing surface and extends in a direction that intersects with the first facing surface from the first facing surface toward the seal plate,
wherein the seal plate has a second facing surface that faces the first facing surface in the rotation axis direction of the impeller shaft, and a second extending surface that is formed continuously with the second facing surface and extend in a direction that intersects with the second facing surface from the second facing surface toward the bearing housing, wherein the second extending surface faces the first extending surface in a radial direction of the impeller shaft, and
wherein the cooling passage is defined by the first facing surface, the first extending surface, the second facing surface, and the second extending surface.

2. The turbocharger according to claim 1, wherein a plurality of sealing members is provided between the bearing housing and the seal plate so as to prevent lubricating oil in the bearing housing from flowing into the cooling passage through a gap between the bearing housing and the seal plate.
